(19) United States
(12) Patent Application Publication
(10) Pub. No.: US 2026/0205531 A1
(43) Pub. Date: Jul. 16, 2026

(54) Cell Phone Keyboard

(71) Applicant: Yuanmu ZHU, Guangdong (CN)

(72) Inventor: Yuanmu ZHU, Guangdong (CN)

(21) Appl. No.: 19/016,034

(22) Filed: Jan. 10, 2025

(51) Int. Cl. H04M 1/02

(52) U.S. Cl. CPC H04M 1/0256

(57) ABSTRACT

The present disclosure provides a cell phone keyboard applicable for a touch-control smart phone, which comprises a keyboard and a connector, wherein the keyboard is configured to be wirelessly connected with a smart phone and input data to the smart phone, and the connector comprises a base, wherein the base is configured to be detachably attached to the back of the smart phone, and the base is provided with an adjustable arm which is telescopically movable; the adjustable arm has a protruding end relatively far from the base, and the keyboard is rotatably connected to the protruding end. Using wireless data transmission between the cell phone keyboard and the cell phone, the cell phone keyboard can be attached to the back of the cell phone by magnets, and the keyboard function area can be stored and hidden on the back of the cell phone in a telescoping manner.

### TECHNICAL FIELD

The present disclosure relates to the technical field of cell phone accessories, in particular to a cell phone keyboard applicable for a touch-control smart phone.

### BACKGROUND

With the popularity of smart phones, full-touch-screen cell phones have become the mainstream. However, for users who are used to using physical keyboards, there are many inconveniences when inputting a large number of words, such as slow input speed and easy mistakes.

In order to solve this problem, independent cell phone keyboards have been developed in the industry in the past, for example US patent No. 8155713 and US patent No. US20070178852A1 and US patent No. US20060066740A1. All the above documents put forward cell phone keyboards applicable for early cell phones. As an independent individual, such keyboards provide a more convenient input method. However, special storage accessories are required for storage and carrying, which is not conducive to portable travel. Some cell phone keyboards and cell phone cases are integrated, and data communication with cell phones is realized by direct physical connection.

However, there are some inconveniences in the above designs: the addition of the cell phone keyboard will definitely affect the volume of the cell phone when it is used, and it is not necessary to input text all the time when using the cell phone, therefore it will be very inconvenient when switching scenes between use, carrying and storage of the cell phone keyboard, which will affect the user experience.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure relates to a cell phone keyboard applicable for a touch-control smart phone, which includes a keyboard and a connector, wherein the keyboard is configured to be wirelessly connected with the smart phone and input data to the smart phone, and the connector includes a base, wherein the base is configured to be detachably attached to the back of the smart phone; and the base is provided with an adjustable arm which is telescopically movable, the adjustable arm has a protruding end relatively far from the base, and the keyboard is rotatably connected to the protruding end. Using wireless data transmission between the cell phone keyboard and the cell phone, the cell phone keyboard can be attached to the back of the cell phone through magnets, and the keyboard function area can be stored and hidden on the back of the cell phone in a telescoping manner.

### BRIEF DESCRIPTION OF DRAWINGS

The drawings, which constitute a part of this application, are used to provide a further understanding of the present disclosure, and the illustrative embodiments of the present disclosure and the descriptions thereof are used to explain the present disclosure, and do not constitute undue limitations on the present disclosure. In the drawings:

FIG. 1 shows a structural schematic diagram of an embodiment of a cell phone keyboard according to the present invention;

FIG. 2 shows another perspective structural diagram of the cell phone keyboard in FIG. 1;

FIG. 3 shows a schematic diagram of the internal structure of the base in FIG. 1;

FIG. 4 shows the structural schematic diagram of the adjustable arm in FIG. 1;

FIG. 5 shows another structural schematic view of the adjustable arm in FIG. 4;

FIG. 6 shows a structural schematic diagram of the mounting block in FIG. 1;

FIG. 7 shows another structural schematic view of the mounting block in FIG. 6;

FIG. 8 shows a schematic diagram of the internal structure of the keyboard in FIG. 1.

The above drawings include the following reference signs:

Keyboard (1); Base (2); Adjustable arm (3); Button (11); Mounting block (12); Keyboard body shell (13); Power switch (14); Charging interface (15); Buckle groove (121); Slot (131); Button (132); Spring member (133); Buckle body (134); Attachment surface (21); Cavity (22); Opening (23); First guide block (24); First arm (31); Second arm (32); Hinge shaft (33); First guide groove (311); Guide post (312); Sliding table (313); Pin slot (321); Sliding chute (322); First magnetic attraction member (41); Second magnetic attraction member (42); Third magnetic attraction member (43); Fourth magnetic attraction member (44); Fifth magnetic attraction member (45).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

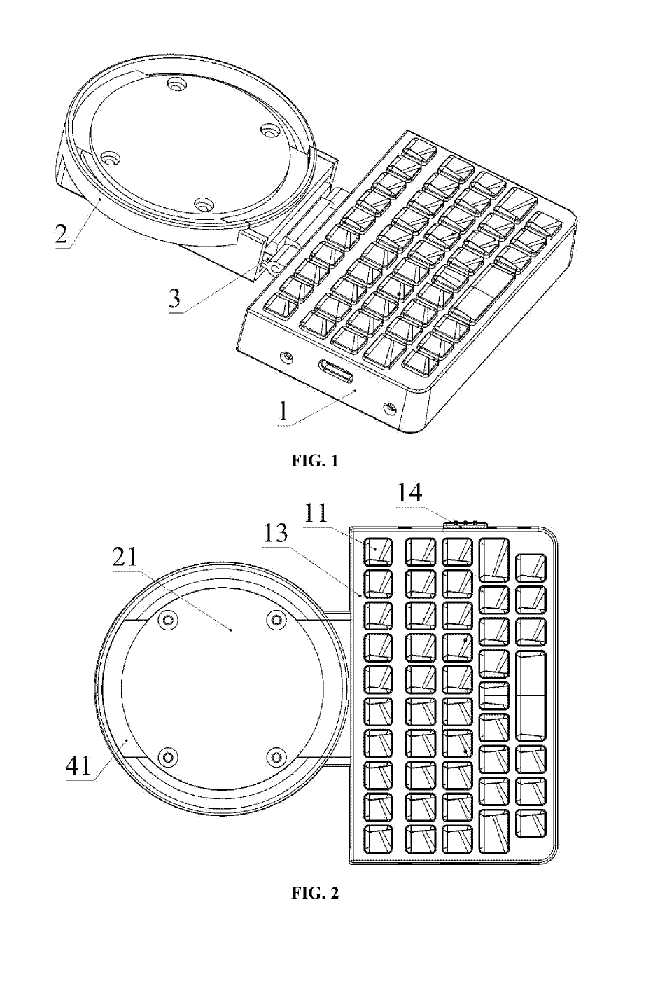

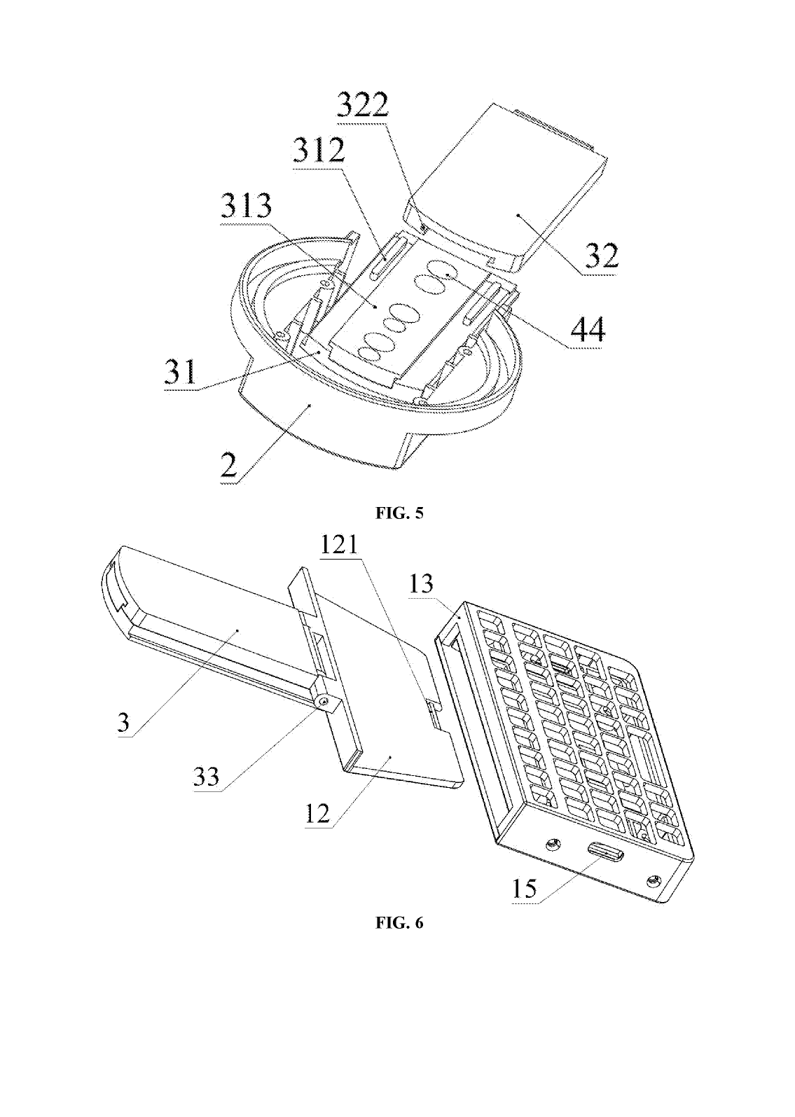

As shown in FIG. 1, FIG. 4 and FIG. 5, the present invention provides a cell phone keyboard applicable for a touch-control smart phone, which includes a keyboard 1 and a connector. The keyboard 1 is configured to be wirelessly connected with a smart phone and input data to the smart phone, and the connector includes a base 2. The base 2 is configured to be detachably attached to the back of the smart phone, and when the base 2 is attached to the smart phone, the spatial position of the keyboard 1 relative to the smart phone can be adjusted through an adjustable arm 3.

A smart phone can be a general term for the types of cell phones with independent operating system and operating space, which can be provided by third-party service providers, such as software, games and navigation, and can realize wireless network access through mobile communication networks.

The base 2 is provided with an adjustable arm 3 which can move telescopically, and the adjustable arm 3 has a protruding end which is relatively far away from the base 2. The keyboard 1 is rotatably connected to the protruding end. By wireless data transmission between the cell phone keyboard and the cell phone, the cell phone keyboard can be attached to the back of the cell phone through magnets, and the keys can be exposed in the functional area of the keyboard 1 in a telescoping manner. The adjustable arm 3 has enough telescopic stroke to meet the different distances when the keyboard 1 moves relative to the base 2, and the angle when the keyboard 1 rotates relative to the adjustable arm 3 can be adjusted to meet the use needs of users.

As shown in FIGS. 1 and 2, the base 2 is provided with an attachment surface 21 connected with the smart phone, and the attachment surface 21 is provided with a first magnetic attraction member 41. The base 2 is magnetically attracted to the back of the smart phone through the first magnetic attraction member 41. The problem of inconvenience caused by the integrated design of the cell phone keyboard and the cell phone case in the prior art is solved. The cell phone keyboard can be adsorbed on the back of the cell phone through a magnet, without being limited by the cell phone case, and does not increase the overall volume of the cell phone. In some embodiments (not shown), the connection between the base 2 and the smart phone can be realized by providing components such as adhesive, hook and loop, fasteners and suction cups, which can be conveniently assembled and disassembled quickly. Moreover, the base 2 and the smart phone can be indirectly connected, and the base 2 can be connected to the phone case or the phone case on the smart phone, and this connection can also be realized through the quick-release structure mentioned above.

It should also be noted that the magnetic base 2 of this embodiment is mainly applicable for smart phones with built-in magnetic blocks. Of course, this magnetic base 2 is also applicable for other cell phones with built-in magnetic blocks or magnetic metal blocks. For a cell phone without a magnetic block or a magnetic metal block inside, an external magnetic block or an external magnetic metal block can be fixed on the cell phone by pasting, covering, etc., and then the magnetic base 2 is used in cooperation with the cell phone. Obviously, a magnetic metal block is a metal block that can be attracted by a magnet.

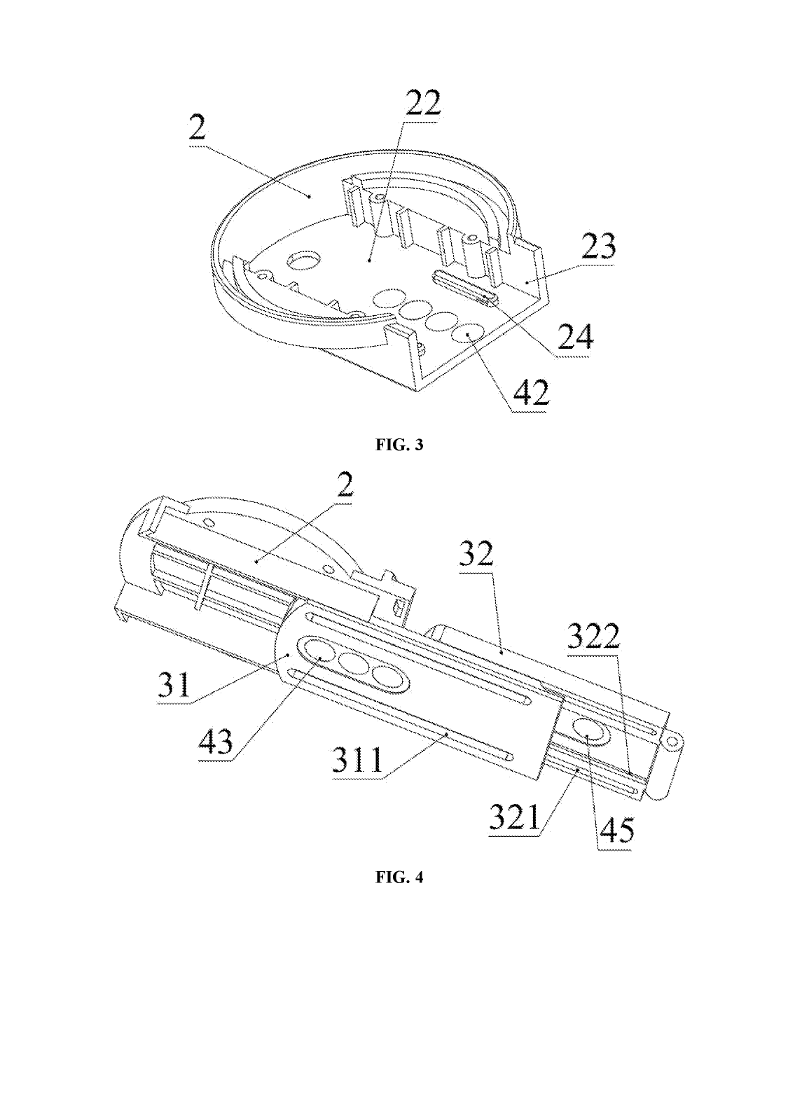

As shown in FIGS. 3 to 5, the base 2 is provided with a cavity 22 for accommodating the adjustable arm 3 and an opening 23 communicating with the cavity 22. The first track is disposed in the cavity 22 and extends to the opening 23, and the adjustable arm 3 is disposed in the cavity 22 and extends out of and retracts from the opening 23. The adjustable arm 3 can be accommodated in the cavity 22 of the base 2 through telescopic movement, so that the keyboard 1 can be stored to abut against the base 2 when the adjustable arm 3 is completely contracted, and the overall volume in the stored state is reduced. The cavity 22 may be relatively open or closed as in this embodiment, that is, the base 2 may have more than one opening 23 communicating with the cavity 22, which facilitates the switching between using and storing scenes of the cell phone keyboard, and also provides a component for storing the keyboard 1.

As shown in FIGS. 3 to 5, the base 2 is provided with a first track, and the adjustable arm 3 is slidably disposed on the first track. The adjustable arm 3 includes a first arm 31 and a second arm 32. The first arm 31 is slidably disposed on the first track, the first arm 31 is provided with a second track, and the second arm 32 is slidably disposed on the second track. The keyboard 1 is rotatably connected to an end of the second arm 32 far away from the base 2, and the end of the second arm 32 far away from the base 2 constitutes the protruding end.

As shown in FIGS. 3 to 5, both the first arm 31 and the second arm 32 are plate-shaped. The first track includes a first guide block 24 disposed on the base 2. The first guide block 24 extends along a surface of the base 2 to define a telescopic direction of the first arm 31, and the first arm 31 is provided with a first guide groove 311 slidably connected with the first guide block 24. The second track includes a second guide block disposed on the first arm 31, and the second guide block extends along the telescopic direction to define a telescopic direction of the second arm 32. The second arm 32 is provided with a second guide groove slidably connected with the second guide block. The second guide block includes a guide post 312 and a sliding table 313 disposed on the first arm 31, and guide rails are disposed on both sides of the sliding table 313. The bottom of the second arm 32 is provided with a pin slot 321 matched with the guide post 312 and a sliding chute 322 matched with the guide rails on both sides of the sliding table 313.

The telescopic arrangement of the above-mentioned adjustable arm 3 is mainly realized by track sliding, and the telescopic arrangement is mainly to realize the linear movement of the keyboard 1 connected with the adjustable arm 3 relative to the base 2, so as to adjust the distance of the keyboard 1 relative to the base 2. Therefore, in some embodiments (not shown), the telescopic arrangement of the adjustable arm 3 may also be realized by configuring the adjustable arm 3 in connection modes such as sleeve telescopic, rack telescopic and hinge fork frame.

In some embodiments (not shown), the adjustable arm 3 can be designed to rotate relative to the base 2. More preferably, one end of the adjustable arm 3 is rotatably connected with the base 2, and the other end is rotatably connected with the keyboard 1, thus forming a structure similar to a three-section rotating bracket. Further, each section of the adjustable arm 3 can be designed to be telescopic, so as to increase the range of motion and provide more flexible adjusting functions.

On the basis that the adjustable arm 3 can be designed to rotate relative to the base 2, the adjustable arm 3 can also slide relative to the base 2. The implementation is that one end of the adjustable arm 3 is provided with a rotating shaft slidably connected with the base 2, and the adjustable arm 3 slides relative to the base 2 through the rotating shaft. After sliding to a proper position, the adjustable arm 3 further rotates to a proper angle around the rotating shaft to realize more accurate adjustment. Similarly, a similar structure can be provided between the first arm 31 and the second arm 32, so as to realize the sliding and rotation of the adjustable arm 3 relative to the base 2.

As shown in FIG. 3 to FIG. 5, there is a magnetic locking function in the adjustable arm 3, and between the adjustable arm 3 and the base 2, and the telescopic length of the adjustable arm 3 is maintained by magnetic locking, which is equivalent to maintaining the keyboard 1 at a required distance from the base 2. The base 2 is provided with a second magnetic attraction member 42, second magnetic bodies are respectively disposed in the cavity 22 near the opening 23. The first arm 31 is provided with a third magnetic attraction member 43, and when the first arm 31 extends out, the second magnetic attraction member 42 and the third magnetic attraction member 43 are attracted to each other to keep the extending length of the first arm 31 relative to the base 2. The first arm 31 is provided with at least one fourth magnetic attraction member 44, and the second arm 32 is provided with a fifth magnetic attraction member 45. When the second arm 32 extends out, the fifth magnetic attraction member 45 and the fourth magnetic attraction member 44 are attracted to each other to keep the extending length of the second arm 32 relative to the first arm 31.

In addition to the magnetic locking function, there are other ways to achieve the locking for the adjustable arm 3: a damped sliding connection is disposed between the adjustable arm 3 and the base 2, and an elastic pin is disposed between the adjustable arm 3 and the base 2.

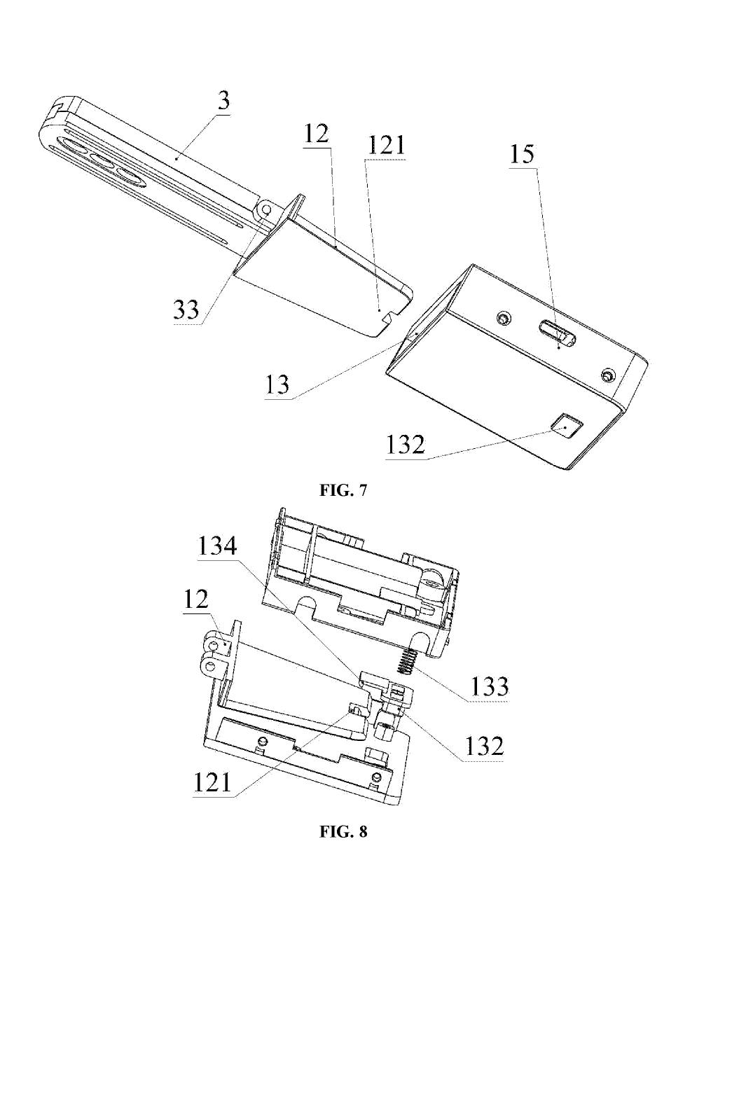

As shown in FIGS. 6 to 8, the keyboard 1 includes a mounting block 12 rotatably connected with the adjustable arm 3 and a keyboard body shell 13 detachably connected with the mounting block 12. The mounting block 12 is rotatably connected with the adjustable arm 3 through the hinge shaft 33, so that the keyboard 1 is rotatably connected with the adjustable arm 3, and the mounting block 12 rotates around the hinge shaft 33 to adjust the angle relative to the base 2. The adjustable arm 3 is further provided with a slot position to avoid the hinge shaft 33. In this embodiment, specifically, the end of the second arm 32 is provided with a slot position to accommodate the hinge shaft 33.

The keyboard body shell 13 is provided with a slot 131 for inserting the mounting block 12, and the keyboard body shell 13 is further provided with a releasable locking mechanism for locking the mounting block 12 after the mounting block 12 is inserted into the slot 131. The mounting block 12 is detachably connected to the keyboard body shell 13 by the locking mechanism.

As shown in FIG. 8, the mounting block 12 is provided with a buckle groove 121, and the outer surface of the keyboard body shell 13 is provided with a mounting opening communicating with the slot 131. The mounting opening is disposed corresponding to the position of the buckle groove 121 when the mounting block 12 is inserted into the slot 131. The locking mechanism includes a button 11 disposed in the mounting opening, a spring element for resetting the button 11 after being pressed, and a buckle body 134 disposed on the button 11. After the mounting block 12 is inserted into the slot 131, the buckle body 134 is buckled into the buckle groove 121 to prevent the mounting block 12 from disengaging. The locking mechanism can also be realized by a magnetic locking mechanism, in which magnets are embedded in the mounting block 12 and the slot 131, and the mounting block 12 is fixed by magnetic attraction. It may also be achieved by a rotating locking mechanism, in which screw structures are designed on the mounting block 12 and the slot 131, and the mounting block 12 is rotated to be tightly engaged with the slot 131. This way can provide stronger locking force and is easy to operate. It may also be achieved by a buckle locking mechanism, in which the mounting block 12 and the slot 131 are designed with a buckle structure, and the mounting block 12 is fixed through the elastic deformation of the buckle. This method is easy to operate and applicable for frequent disassembly and assembly.

A wireless module is disposed in the keyboard 1, and the wireless module establishes a wireless connection with the smart phone through wireless local area network (WLAN), Zigbee (IEEE 802.15.4), Bluetooth, infrared communications, World Interoperability for Microwave Access (WiMAX), Global System for Mobile Communications (GSM), General Packet Radio Service (GPRS), Third Generation (3G) or Actor Network Theory + (Ant+) technologies, realizing typing information such as text into smart phone. The defect that data communication is realized between the cell phone keyboard and the cell phone in the prior art is solved. Wireless data transmission is carried out between the cell phone keyboard and the smart phone, so that the flexibility is improved.

The keyboard 1 is provided with a rechargeable power supply, and the keyboard 1 is provided with a corresponding power switch 14 and a charging interface 15. The keyboard 1 has a text input keypad, which is equivalent to the current 26-key format, and is shown as a Roman typewriter or computer keyboard (commonly called "QWERTY") configuration.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A cell phone keyboard applicable for a touch-control smart phone, comprising a keyboard and a connector, wherein the keyboard is configured to be wirelessly connected with a smart phone and input data to the smart phone, and the connector comprises a base, wherein the base is configured to be detachably attached to the back of the smart phone, and the base is provided with an adjustable arm which is telescopically movable; and the adjustable arm has a protruding end relatively far away from the base, and the keyboard is rotatably connected to the protruding end.

2. The cell phone keyboard according to claim 1, wherein the base is provided with an attachment surface connected with the smart phone, a first magnetic attraction member is disposed in the attachment surface, and the base is magnetically attracted to the back of the smart phone through the first magnetic attraction member.

3. The cell phone keyboard according to claim 1, wherein the base is provided with a first track, and the adjustable arm is slidably disposed on the first track.

4. The cell phone keyboard according to claim 3, wherein the adjustable arm comprises a first arm and a second arm, wherein the first arm is slidably disposed on the first track, the first arm is provided with a second track, and the second arm is slidably disposed on the second track; and the keyboard is rotatably connected to an end of the second arm far from the base, and the end of the second arm far from the base constitutes the protruding end.

5. The cell phone keyboard according to claim 4, wherein both the first arm and the second arm are plate-shaped, and the first track comprises a first guide block disposed on the base; and the first guide block extends along a surface of the base to define a telescopic direction of the first arm, and the first arm is provided with a first guide groove slidably connected with the first guide block; and the second track comprises a second guide block disposed on the first arm, and the second guide block extends along the telescopic direction to define a telescopic direction of the second arm, and the second arm is provided with a second guide groove slidably connected with the second guide block.

6. The cell phone keyboard according to claim 5, wherein the second guide block comprises a guide post and a sliding table disposed on the first arm, and guide rails are disposed on both sides of the sliding table; and a bottom of the second arm of the second arm is provided with a pin slot matched with the guide post and a sliding chute matched with the guide rails on both sides of the sliding table, wherein the pin slot and the sliding chute together constitute the second guide groove.

7. The cell phone keyboard according to claim 4, wherein a cavity for accommodating the adjustable arm and an opening communicating with the cavity are provided in the base, the first track is disposed in the cavity and extends towards the opening, and the adjustable arm is disposed in the cavity and extends out of and retracts from the opening.

8. The cell phone keyboard according to claim 7, wherein the base is provided with a second magnetic attraction member, and second magnetic bodies are respectively disposed at a position in the cavity near the opening; the first arm is provided with a third magnetic attraction member, and when the first arm is extended, the second magnetic attraction member and the third magnetic attraction member are mutually attracted to keep an extending length of the first arm relative to the base; and the first arm is provided with at least one fourth magnetic attraction member, the second arm is provided with a fifth magnetic attraction member, and when the second arm is extended out, the fifth magnetic attraction member and the fourth magnetic attraction member are attracted to each other to keep an extending length of the second arm relative to the first arm.

9. The cell phone keyboard according to claim 1, wherein the keyboard comprises a mounting block rotatably connected with the adjustable arm and a keyboard body shell detachably connected with the mounting block.

10. The cell phone keyboard according to claim 9, wherein the keyboard body shell is provided with a slot for inserting the mounting block, the keyboard body shell is further provided with a releasable locking mechanism for locking the mounting block after the mounting block is inserted into the slot, and the mounting block is detachably connected to the keyboard body shell by the locking mechanism.

11. The cell phone keyboard according to claim 10, wherein the mounting block is provided with a buckle groove, an upper outer surface of the keyboard body shell is provided with a mounting opening communicating with the slot, and the mounting opening is disposed corresponding to a position of the buckle groove when the mounting block is inserted into the slot; and the locking mechanism comprises a button disposed in the mounting opening, a spring element for resetting the button after being pressed, and a buckle body disposed on the button; and after the mounting block is inserted into the slot, the buckle body is buckled into the buckle groove to prevent the mounting block from being detached.

12. The cell phone keyboard according to claim 9, wherein the mounting block is rotatably connected with the adjustable arm through a hinge shaft, and the mounting block rotates around the hinge shaft to adjust an angle relative to the base.

13. The cell phone keyboard according to claim 1, wherein the keyboard is provided with a power switch and a charging interface.

14. A cell phone keyboard applicable for a touch-control smart phone, comprising
a base configured to be detachably attached to the back of the smart phone; and
a keyboard configured to be wirelessly connected with the smart phone and input data to the smart phone; and
an adjustable arm disposed on the base and configured for connecting the base and the keyboard;
wherein when the base is attached to the smart phone, the keyboard can adjust a spatial position thereof relative to the smart phone through the adjustable arm.

15. The cell phone keyboard according to claim 14, wherein the keyboard comprises a mounting block and a keyboard body shell, and keys are disposed on the keyboard body shell; and the mounting block is connected to an adjustable arm, and the keyboard body shell is detachably connected with the mounting block.

16. The cell phone keyboard according to claim 15, wherein the keyboard body shell is provided with a slot for inserting the mounting block, the keyboard body shell is further provided with a releasable locking mechanism for locking the mounting block after the mounting block is inserted into the slot, and the mounting block is detachably connected to the keyboard body shell by the locking mechanism.

17. The cell phone keyboard according to claim 15, wherein the mounting block is rotatably connected with the adjustable arm through a hinge shaft, and the mounting block rotates around the hinge shaft to adjust an angle relative to the base.

18. The cell phone keyboard according to claim 14, wherein the base is provided with a first track, and the adjustable arm comprises a first arm and a second arm, wherein the first arm is slidably disposed on the first track, and the first arm is provided with a second track, wherein the second arm is slidably disposed on the second track, and the keyboard is rotatably connected to an end of the second arm far from the base.

19. A cell phone keyboard applicable for a touch-control smart phone, comprising
a base configured to be detachably attached to the back of the smart phone; and
a keyboard configured to be wirelessly connected with the smart phone and input data to the smart phone, and is adapted for being at least partially hidden to the back of the smart phone in a stacked form; and
an adjustable arm configured to be used for connecting the base and the keyboard, and is disposed on the base and is telescopic relative to the base;
wherein, the keyboard is rotatably connected to the adjustable arm, so that the keyboard can rotate to adjust a use angle thereof, and the keyboard moves along with the extension and retraction of the adjustable arm, by which the keyboard can move to adjust a distance relative to the base.

20. The cell phone keyboard according to claim 19, wherein the keyboard comprises a mounting block and a keyboard body shell, wherein the mounting block is rotatably connected to the adjustable arm, and the keyboard body shell is provided with a slot for inserting the mounting block; and the keyboard body shell is further provided a releasable locking mechanism for locking the mounting block after the mounting block is inserted into the slot, and the mounting block is detachably connected to the keyboard body shell by the locking mechanism.
